(19) United States
(12) Patent Application Publication
(10) Pub. No.: US 2004/0203375 A1
(43) Pub. Date: Oct. 14, 2004

(54) Telemetry method and system

(75) Inventor: James Chen, Taoyuan Hsien (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taoyuan Hsien (TW)

(21) Appl. No.: 10/309,288

(22) Filed: Dec. 4, 2002

(30) Foreign Application Priority Data
Sep. 3, 2002 (TW) 091120103

(51) Int. Cl. H04B 5/00; H04Q 7/20; H04B 1/38

(52) U.S. Cl. 455/41.2; 455/557; 455/466

(57) ABSTRACT

A telemetry method and system is mainly used to transmit a short message from a short message from a data center to a far-end controlled device through a cellular phone net. The far-end controlled device starts to search all meter reading reporter devices around it after it receives the short message, and then, builds a Bluetooth connection with each meter reading reporter device to read the readings. Thereafter, the far-end controlled device reports all the readings to the data center after they are all read. Thereby, a new wireless net needs not to be built so that a telemetry cost can be cut down.

### TECHNICAL FIELD

The present invention relates to a telemetry method and system, and more particularly to a telemetry method and system that uses the current cellular phone network as a basic structure for processing telemetry.

### TECHNICAL BACKGROUND

Far end remote control function must be furnished in each meter reading reporter device for a conventional telemetry system. Thereby, the meter reading reporter device can transmit the readings read by a meter therein back to a reading data center. Under such circumstance, a large amount of reading reporter devices with far end remote control function must be installed in whole system, thereby, a large number of cost must be involved. Besides, the currently existing network cannot be used in the conventional telemetry system; a large amount of cost must be spent in building another brand new wireless network system. Therefore, a cost-down and easily processed telemetry is expected.

### SUMMARY OF THE PRESENT INVENTION

A telemetry method and system according to the present invention uses cellular phone function and Bluetooth function to a telemetry work. The system of the present invention comprises a far end remote control device and a plurality of reading reporter devices. The far end control device collects the meter readings of every reading reporter device in sequence after it receives a short message command from a data center, and then, transmits all the readings back to the data center.

Therefore, one object of the present invention is to provide a telemetry method and system, a currently existed cellular phone network is used as a basic structure for a telemetry work so that a large amount of cost to build another brand new wireless network for a telemetry work is saved.

Another object of the present invention is to provide a telemetry method and system; a cheaper Bluetooth module is used in a reading reporter device, and the readings of a plurality of reading reporter device is reported through a same far end remote control device, this can save huge prime cost so that a telemetry work can be easily processed.

### BRIEF DESCRIPTION OF THE PRESENT INVENTION

Other objects, features, and advantages of the invention will become apparent from the following detailed description of the preferred but non-limiting embodiments. The description is made with reference to the accompanying drawings in which:

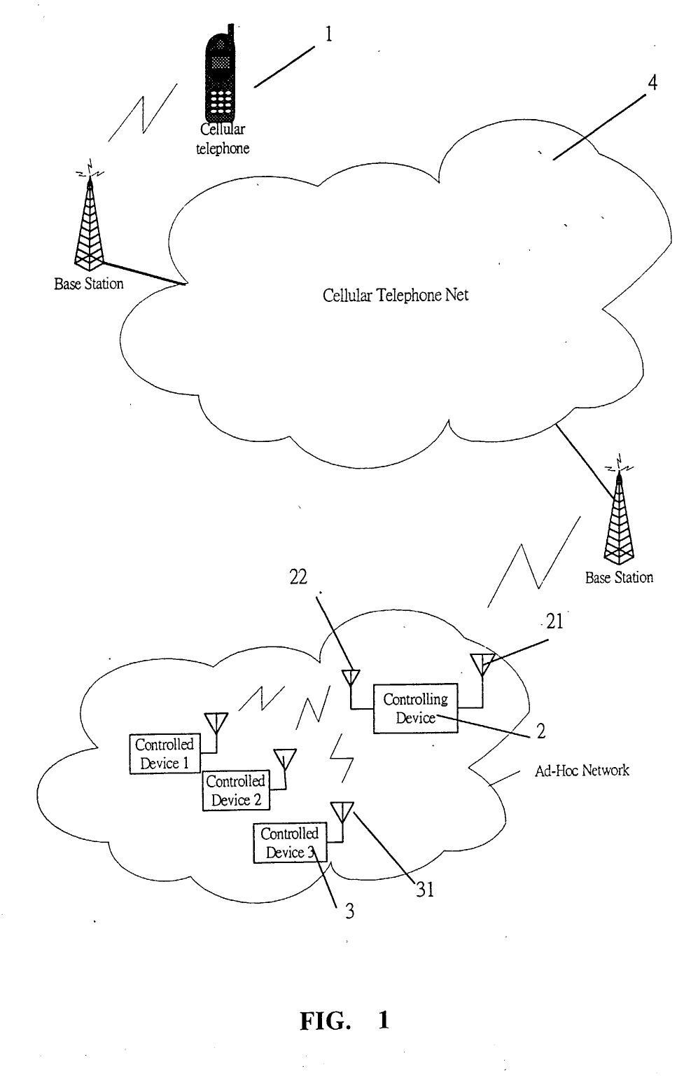

FIG. 1 is a descriptive chart showing a structure of a telemetry system according to a preferred embodiment of the present invention;

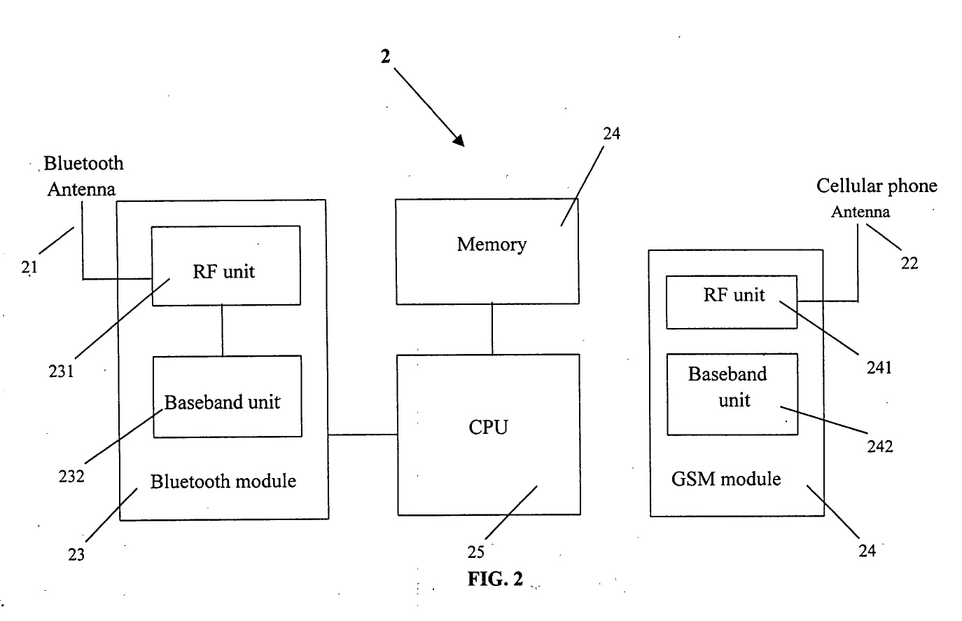

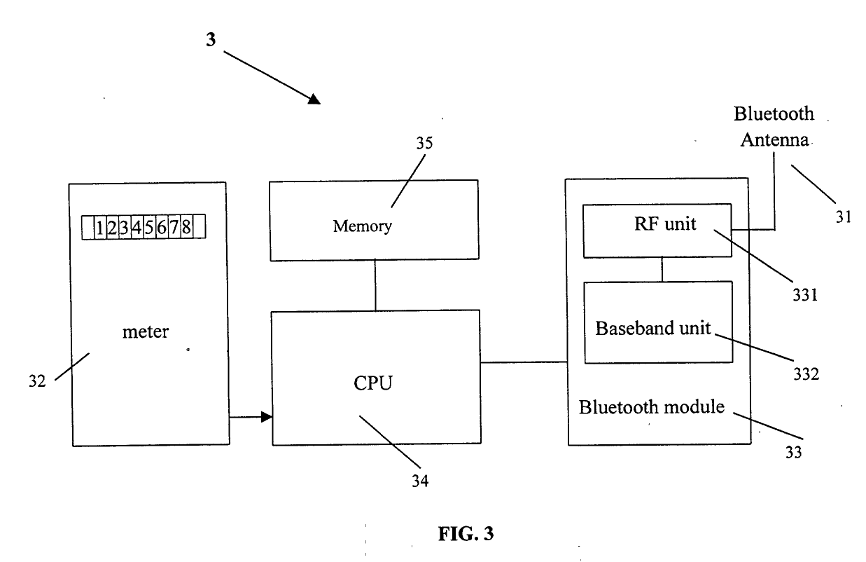

FIG. 2 is a block diagram showing a circuit of a far end remote control device;

FIG. 3 is a block diagram of a reading reporter device with Bluetooth function;

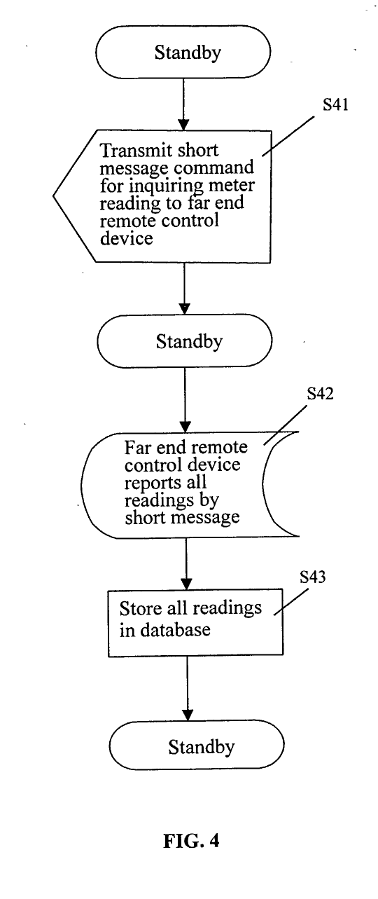

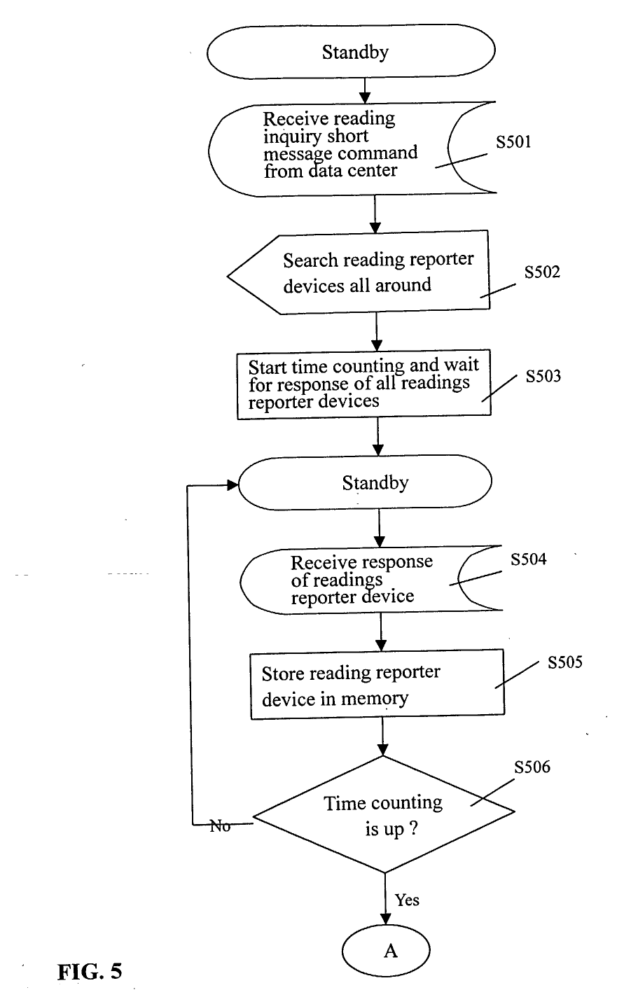

FIG. 4 is a flow chart showing a telemetry operation processed by a data center;

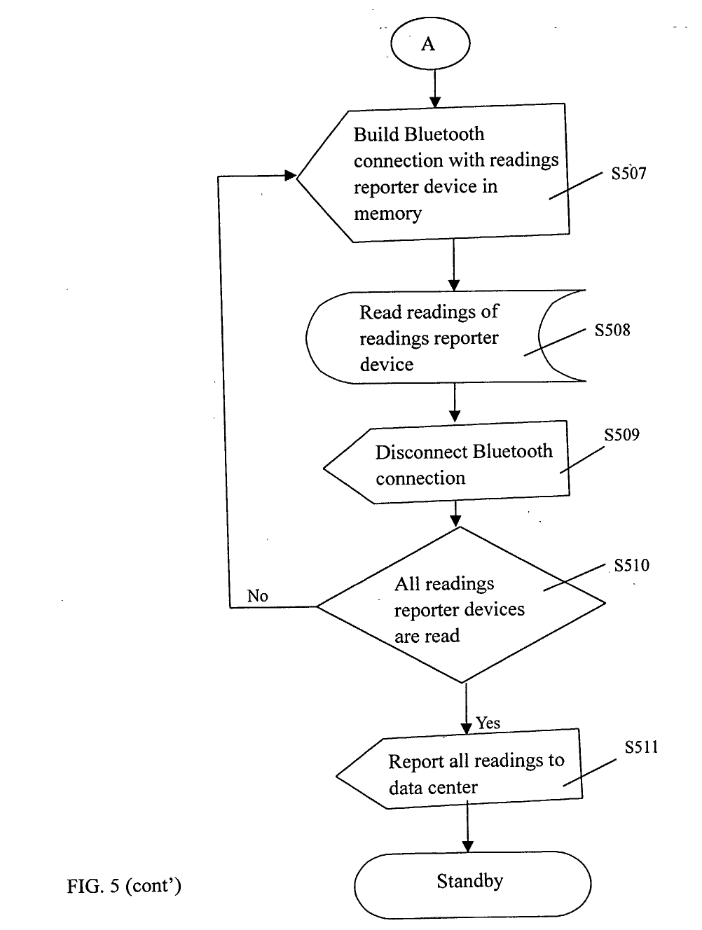

FIG. 5 is a flow chart showing a telemetry operation processed by a far end remote control device; and

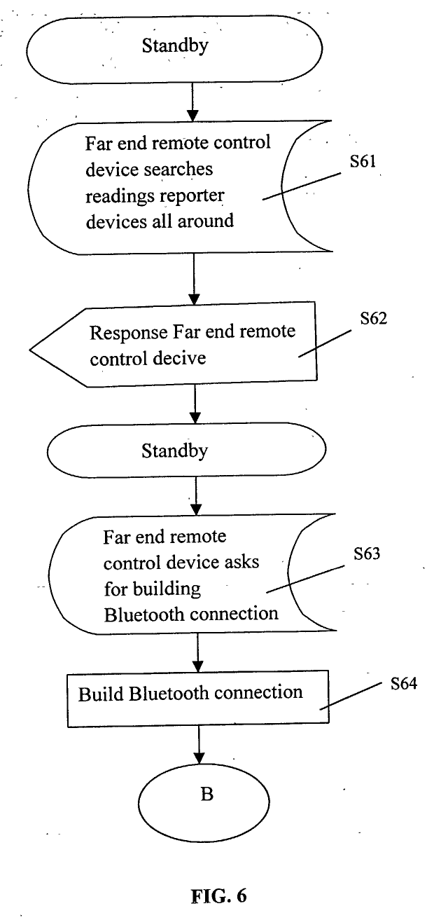

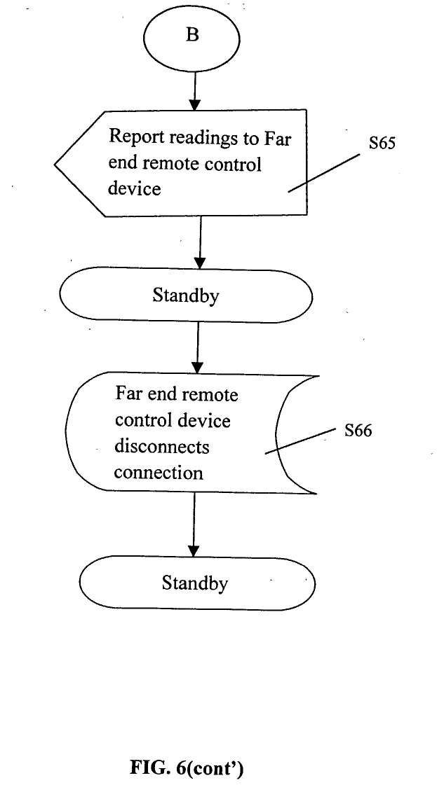

FIG. 6 is a flow chart showing a telemetry operation processed by a reading reporter device.

### DETAILED DESCRIPTION OF THE PRESENT INVENTION

First, refer to FIG. 1, which shows a telemetry system according to the present invention. A telemetry system comprises a data center 1, far end remote control device 2 and a plurality of reading reporter devices 3. Here, the data center is composed of a cellular phone 11, computer 12 and database 13, and a data transmission line is connected between the cellular phone 11 and the computer 12. The reading reporter device 2 has a Bluetooth antenna 21 and cellular phone antenna 22 therein. And, each reading reporter device 3 has a Bluetooth antenna 31. The data center 1 transmits a short message command to the far end remote control device 2 through a cellular phone network 4, and receives the readings of each reading reporter device 2 reported from the far end remote control device 2, and then, stores the readings in the database 13. Further, the far end remote control device 2 searches all reading reporter device 3 around it (device 2 can search Bluetooth devices in 100 meters according to Bluetooth standards) after the far end remote control device 2 receives the reading inquiry short message command emitted from the data center 1. And then, the far end remote control builds a Bluetooth connection with each reading reporter device 3 to read the meter readings thereof. The connection is disconnected after the readings are read. The far end remote control device 2 reports the readings of all reading reporter devices 2 to the data center 1 after the meters in all reading reporter devices are read in sequence. The reading reporter device 3 waits for a connection inquiry from the far end remote control device 2 and builds a connection with it, and then, transmits the meter readings to the far end remote control device 2 after the connection is built. The reading reporter device 3 enters a standby state when the far end remote control device disconnects the connection and waits for a next connection inquiry from the far end remote control.

Next, please refer to FIG. 2, which shows a circuit block diagram for a far end remote control device according to the present invention. Here, the far end remote control device may comprises a Bluetooth module 23, Bluetooth antenna 21 installed thereon, CPU 25, memory 26, cellular phone module 24 and cellular phone antenna 22 installed thereon. Further, the Bluetooth module 23 is composed of a RF unit 231 and Baseband unit 232, and the cellular phone module 24 is composed of a RF unit 241 and Baseband unit 242. Thereby, the far end remote control device 2 receives the short message command transmitted from the cellular phone 11 of the data center 1 and builds a connection with the reading reporter device 3.

Please refer to FIG. 3, which is a circuit block chart showing a reading reporter device according to a preferred embodiment of the present invention. As the figure shows, the reading reporter device 3 is composed of a meter 32 (such as watt-hour meter), CPU 34, memory 35, Bluetooth module 33 and Bluetooth antenna 31 installed thereon. Here, the Bluetooth module 33 consists of a RF unit 331 and Baseband unit 332. Thereby, the reading reporter device 3 can build a connection with the far end remote control device 2 so as to report meter readings to the far end remote control device 2.

As to the steps of a telemetry method according to the present invention, please refer to FIG. 4 to FIG. 6.

First, please refer to FIG. 4, which shows a flow chart for a data center to process a telemetry operation according to the present invention. In the beginning, the data center is at a standby state, an operator transmits a short message concerning meter readings inquiry from the data center to the far end remote control device (step S41). Thereafter, the data center is at the standby state again to wait for a meter reading report. The far end remote control device reports the meter readings of each reading reporter device to the data center by a short message (step S42) during waiting, the data center stores the readings in a database (step S43). And then, the data center is at the standby state again to wait for a next telemetry assignment.

Next, please refer to FIG. 5, which shows a flow chart for a far end remote control device according to the present invention. In the beginning, the far end remote control operation is at a standby state. The far end remote control device receives a short message command concerning a meter readings inquiry from a data center at the standby state (step S501), searches all reading reporter devices around it (step S502), and waits for the all reading reporter device to response while a time counting is begun (step S503). Thereafter, the far end remote control device enters the standby state again. A reading reporter device may response at that state (step S504), the far end remote control device stores the number of this reading reporter device in a memory thereof (step S505), and then, checks whether the counting time is up (step S506). The far end remote control device enters the standby state again if the counting time is not up, receives the response of another reading reporter device at step S504, and continues the following steps. If the counting time is up, the far end remote control device builds a Bluetooth connection with a reading reporter device whose number is stored in the memory (step S507), reads the readings of that reading reporter device (step S508), disconnects the Bluetooth connection (step S509), and then, check whether the readings of all reading reporter devices are read (step S510). If it is not, then repeat step S507 to S510 until the readings in all meters are read. If it is, the far end remote control device reports all the readings to the data center (step S511), and then, the far end remote control device enters the standby state again.

Finally, please refer to FIG. 6, which is a flow chart for showing an operation of a reading reporter device according to the present invention. First, a reading reporter device receives a command that a far end remote control device searches all the reading reporter devices around it when the reading reporter device is at a standby state (step S61), it responses to the far end remote control device (step S62), and then, enters the standby state again. The far end remote control device demands the reading reporter device to build a Bluetooth connection with it (step S63), the reading reporter device builds the connection with it (step S64), reports the meter readings to it (step 65), and then, enters the standby state again. The far end remote control disconnects the connection, and then, the reading reporter device returns back to the standby state.

It is noted that the telemetry method and system described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A telemetry system, mainly comprising:
a data center for transmitting and receiving a short message command, mainly consisting of a cellular phone and computer, said cellular phone connected with said computer by a data transmission line;
a far end remote control device, transmitting and receiving a short message command and furnished with Bluetooth function, mainly consisting of a cellular phone module, Bluetooth module, memory and CPU; and
a plurality of reading reporter devices with Bluetooth function, each of said devices mainly consisting a Bluetooth module, memory, CPU and meter;
wherein, said data center is responsible for transmitting said short message to said far end remote control device, and receiving meter readings of each said reading reporter device reported from said far end remote control device.

2. The system of claim 1, wherein said far end remote control device searches all said reading reporter devices around in a range after said far end remote control device receives said short message command.

3. The system of claim 2, wherein said range is 100 meters.

4. The system of claim 2, wherein said far end remote control device builds a Bluetooth connection with said reading reporter device and reads meter readings in said reading reporter device after said reading reporter device is found.

5. The system of claim 3, wherein said far end remote control device builds a Bluetooth connection with said reading reporter device and reads meter readings in said reading reporter device after said reading reporter device is found.

6. The system of claim 4, wherein said Bluetooth connection is disconnected after said reading is read.

7. The system of claim 6, wherein said far end remote control device reports all said reading values in all said reading reporter devices to said data center by a short message after all said reading values are read.

8. The system of claim 6, wherein said reading reporter device enters a standby state after said Bluetooth connection is disconnected.

9. A telemetry method, mainly comprising the following steps:
(1) a data center transmitting a short message command to a far end remote control device;
(2) said far end remote control device searching all reading reporter devices around it after receiving said short message command;
(3) said far end remote control device building a Bluetooth connection with a reading reporter device and read a meter readings from said reporter device after said reading reporter device is found;
(4) said reading reporter device transmitting said readings to said far end remote control device;
(5) said far end remote control device disconnecting said Bluetooth connection after said reading is read; and
(6) said far end remote control device reporting all said readings to said data center after said far end remote control device reads all said reading values in all said reading reporter devices.

10. The method of claim 9, wherein said data center stores all said reading values in a database after receives said reading values reported from said far end remote control device.

11. The method of claim 9, wherein all said reading reporter devices are located within 100 meters distanced from said far end remote control device.

12. The method of claim 9, wherein said reading reporter device enters a standby state to wait for next inquiry for building a connection with said far end remote control device after said Bluetooth connection is disconnected in said step (5).
